(19) United States
(12) Patent Application Publication
(10) Pub. No.: US 2017/0054518 A1
(43) Pub. Date: Feb. 23, 2017

(54) METHOD AND ELECTRONIC DEVICE FOR DETERMINING CQI INDEX

(71) Applicant: Samsung Electronics Co., Ltd., Gyeonggi-do (KR)

(72) Inventor: Jung Hoon CHO, Seoul (KR)

(21) Appl. No.: 15/239,158

(22) Filed: Aug. 17, 2016

(30) Foreign Application Priority Data
Aug. 18, 2015 (KR) 10-2015-0115924

(51) Int. Cl. H04B 17/336; H04B 7/06

(52) U.S. Cl. CPC H04B 17/336; H04B 7/0632

(57) ABSTRACT

An electronic device includes a communication circuit configured to communicate with a base station based on a protocol, a memory configured to store one or more applications and one or more schemes for determining channel quality indication (CQI) indices, and a processor configured to determine a CQI index based on a signal received from the base station through the communication circuit and to cause the communication circuit to send the determined CQI index to the base station. The processor selects a scheme for determining the CQI index based on the application being executed. Other embodiments are also possible.

### CLAIM OF PRIORITY

This application claims the benefit under 35 U.S.C. §119(a) of a Korean patent application filed on Aug. 18, 2015 in the Korean Intellectual Property Office and assigned Serial number 10-2015-0115924, the entire disclosure of which is hereby incorporated by reference.

### TECHNICAL FIELD

The present disclosure relates to a method for determining a channel quality indicator (CQI) index of an electronic device in a cellular mobile communication network.

### BACKGROUND

As a long-term evolution (LTE) mobile communication system is distributed, an LTE service is provided. Compared with a conventional mobile communication system such as a 3G system or the like, the LTE mobile communication system has a superior transmission speed, and a variety of services are provided through the mobile communication system based on the superior transmission speed.

In an LTE mobile communication system, an electronic device exchanges data communication with a base station. The electronic device determines channel state information at a location where the electronic device is placed and notifies the base station of the determined channel state information. The base station may perform scheduling, allocating of channel resources, and the like based on the notified channel state information from the electronic device.

### SUMMARY

Aspects of the present disclosure are to provide a method for selectively determining a CQI index as a channel state information based on a feature of an application and an electronic device performing the same.

In accordance with an aspect of the present disclosure, an electronic device includes a communication circuit configured to communicate with a base station based on a protocol, a memory configured to store one or more applications and one or more schemes for determining channel quality indication (CQI) indices, and a processor configured to determine a CQI index based on a signal received from the base station through the communication circuit and to cause the communication circuit to send the determined CQI index to the base station. The processor selects a scheme for determining the CQI index based on the application being executed.

In accordance with an aspect of the present disclosure, a CQI index determining method of an electronic device includes receiving a signal from a base station, executing a specified application on the electronic device, selecting a scheme for determining the CQI index based on the application being executed, determining the CQI index based on the signal according to the selected scheme for determining the CQI index, and sending the CQI index to the base station.

In accordance with an aspect of the present disclosure, in a computer-readable recording medium having recorded thereon instructions which are executed by at least one processor, causing the processor to perform a method comprising receiving a signal from a base station, executing a specified application on the electronic device, selecting a scheme for determining a CQI index based on the application being executed, determining the CQI index based on the signal according to the selected scheme for determining the CQI index, and sending the CQI index to the base station.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating an environment to which various embodiments of the present disclosure are applied;

FIG. 2 illustrates a frame structure of a signal that a base station according to various embodiments of the present disclosure sends to an electronic device;

FIG. 3 illustrates a CQI table of a base station according to various embodiments of the present disclosure;

FIG. 4 is a block diagram illustrating an electronic device according to an embodiment of the present disclosure;

FIG. 5 is a graph for describing relations between an SNR and a CQI index, between an SNR and a BLER, and between an SNR and a transmission rate, according to an embodiment of the present disclosure;

FIG. 6A and FIG. 6B are actual graphs measured for describing relations between an SNR and a CQI index, between an SNR and a BLER, and between an SNR and a transmission rate, according to an embodiment of the present disclosure;

FIG. 7 is a flow chart illustrating a method for determining a CQI index according to an embodiment of the present disclosure;

FIG. 8 is a flow chart illustrating a method for determining a CQI index according to an embodiment of the present disclosure;

FIG. 9 is a block diagram of an electronic device in a network environment according to various embodiments of the present disclosure;

FIG. 10 is a block diagram of an electronic device according to various embodiments of the present disclosure; and

FIG. 11 illustrates a block diagram of a program module according to various embodiments of the present disclosure.

Throughout the drawings, it should be noted that like reference numbers are used to depict the same or similar elements, features, and structures.

### DETAILED DESCRIPTION

Various embodiments of the present disclosure may be described with reference to accompanying drawings. Accordingly, those of ordinary skill in the art will recognize that modification, equivalent, and/or alternative on the various embodiments described herein can be variously made without departing from the present disclosure. With regard to description of drawings, similar components may be marked by similar reference numerals.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, “a first user device” and “a second user device” indicate different user devices regardless of the order or priority. For example, “a first user device” and “a second user device” indicate different user devices. For example, without departing the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. CPU, for example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in this specification are used to describe specified embodiments of the present disclosure and are not intended to limit the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or an implantable type (e.g., an implantable circuit).

According to an embodiment, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles (e.g., Xbox™ and PlayStation™), electronic dictionaries, electronic keys, camcorders, electronic picture frames, and the like.

According to various embodiments, the electronic devices may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global navigation satellite system (GNSS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or interne of things (e.g., light bulbs, various sensors, electric or gas meters, sprinkler devices, fire alarms, thermostats, street lamps, toasters, exercise equipment, hot water tanks, heaters, boilers, and the like).

According to various embodiments, the electronic devices may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof An electronic device according to an embodiment may be a flexible electronic device. Furthermore, an electronic device according to an embodiment may not be limited to the above-described electronic devices and may include other electronic devices and new electronic devices according to the development of technologies.

Hereinafter, electronic devices according to various embodiments of the present disclosure will be described with reference to the accompanying drawings. The term “user” used herein may refer to a person who uses an electronic device or may refer to a device (e.g., an artificial intelligence electronic device) that uses an electronic device.

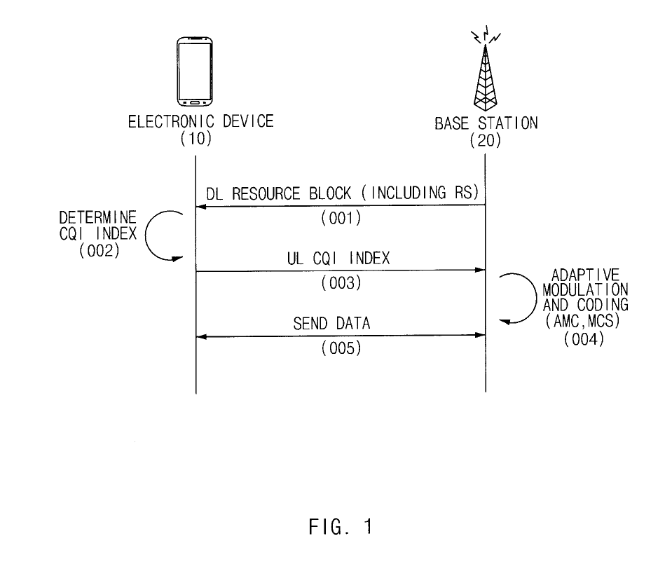

FIG. 1 is a view illustrating an environment to which various embodiments of the present disclosure are applied.

Referring to FIG. 1, in various embodiments of the present disclosure, an electronic device 10 and a base station 20 may communicate with each other.

The electronic device 10 may be implemented with various types of electronic devices and may exchange data and/or control information with the base station 20. The electronic device 10 may be user equipment (UE), terminal equipment, a mobile station (MS), a mobile terminal (MT), a user terminal (UT), a subscribe station (SS), a wireless device, a handheld device, or the like.

The base station (BS) 20 may mean a fixed station that communicates with the electronic device 10 and/or another base station. The base station 20 may be an advanced base station (ABS), a Node-B (NB), an Evolved-NodeB (eNB), a base transceiver system (BTS), an access point (AP), a processing server (PS), or the like.

In operation 001, the base station 20 may send a designated signal to the electronic device 10 through a downlink (DL) channel. According to an embodiment, the designated signal may include a reference signal (RS). For example, the reference signal may be included in a downlink (sub)frame and may be sent to the electronic device 10.

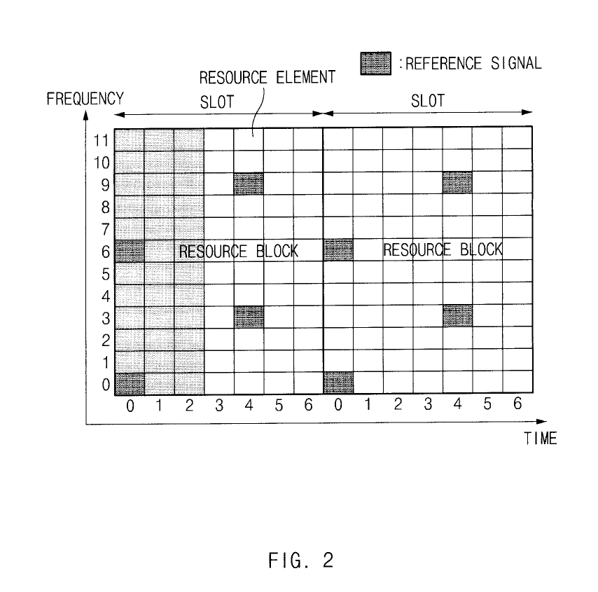

Referring to FIG. 2, an embodiment is exemplified as a LTE downlink subframe is sent from the base station 20 to the electronic device 10. One subframe may have a time length of 1 ms in a time domain and may correspond to twelve subcarriers in a frequency domain. The one subframe may include two slots each of which has a time length of 0.5 ms in a time domain. One slot may be divided into seven orthogonal frequency division multiplexing (OFDM) symbols in a time domain, may correspond to 12 sub-carriers in a frequency domain, and may include 84 resource elements. The set of the 84 resource elements may be used as a resource block. For example, the reference signal may be included in 4 elements among 84 resource elements of the resource block and may be sent to the electronic device 10.

In operation 002, the electronic device 10 may decode the reference signal received from the base station 20, and determine a channel quality indicator (CQI) index. According to an embodiment, in a LTE mobile communication system, the electronic device 10 may periodically (e.g., every 1 ms) or aperiodically measure the quality of a wireless channel (e.g., the quality of a downlink channel) and may send channel state information (CSI) to the base station 20. The CQI index of the CSI may be one of parameters for optimizing the quality of a physical layer signal and may be closely associated with a transmission rate of a terminal.

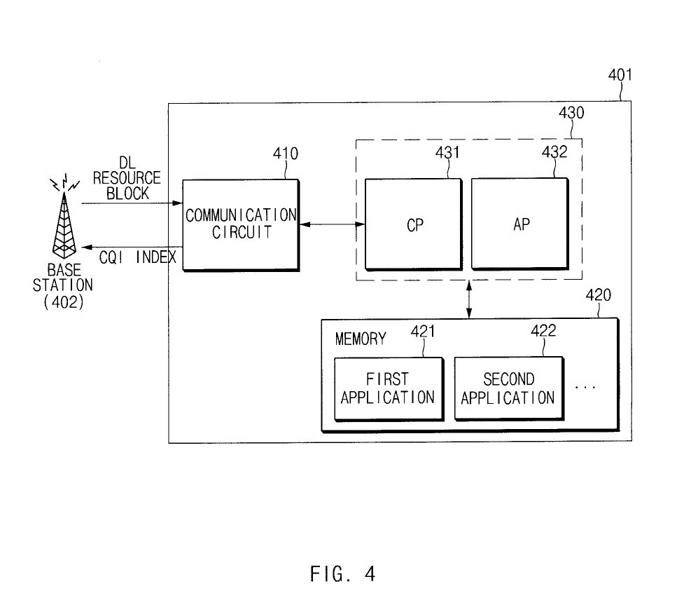

According to various embodiments of the present disclosure, the electronic device 10 may select different schemes for determining the CQI index based on the application which being executed at the electronic device 10 and performing communication between the electronic device 10 and the base station 20. The method for determining the CQI index may be described with reference to FIGS. 4 to 8.

In operation 003, the electronic device 10 may send the CQI index determined in operation 002 to the base station 20. For example, the electronic device 10 may periodically send the determined CQI index to the base station 20 through an uplink control channel (e.g., a physical uplink control channel (PUCCH)). According to another embodiment, the electronic device 10 may aperiodically send the determined CQI index to the base station 20 through an uplink shared channel (e.g., a physical uplink shared channel (PUSCH)).

In operation 004, the base station 20 may perform an adaptive modulation and coding (AMC) based on the CQI index received from the electronic device 10. For example, the base station 20 may set a modulation order and a code rate based on the CQI index, and thus the base station 20 may optimize the transmission rate of data to be suitable for a wireless channel environment.

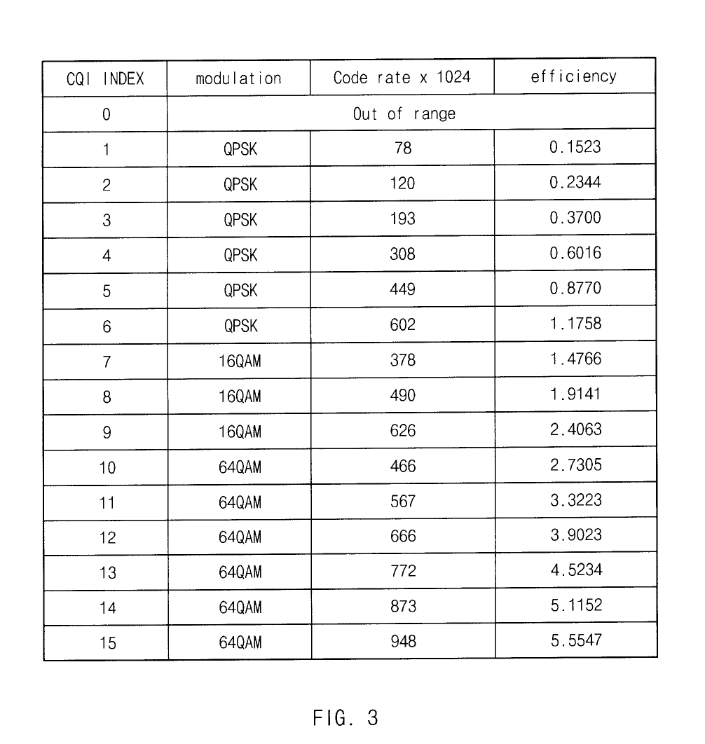

Referring to FIG. 3, for example, the base station 20 may set a modulation order and a code rate corresponding to a CQI index received from the electronic device 10 based on a CQI table illustrated in FIG. 3 (e.g., a modulation coding system (MCS) based on 3GPP TS 36.213 v12.0.0.). For example, in the case where a low CQI index (e.g., CQI index=‘2’) is received from the electronic device 10 due to a degraded channel environment, the base station 20 may apply a low modulation order (e.g., QPSK) and a low code rate (e.g., 120/1024) to a communication with the electronic device 10. For example, in the case where a high CQI index (e.g., CQI index=‘15’) is received from the electronic device 10 due to a good channel environment, the base station 20 may apply a high modulation order (e.g., 64QAM) and a high code rate (e.g., 948/1024) to a communication with the electronic device 10. As such, the base station 20 may perform a link adaptation for optimizing a transmission rate, based on the CQI index received from the electronic device 10.

In operation 005, the base station 20 may exchange data communication with the electronic device 10 based on the modulation order and the code rate set in the operation 004.

FIG. 4 is a block diagram illustrating an electronic device according to an embodiment of the present disclosure.

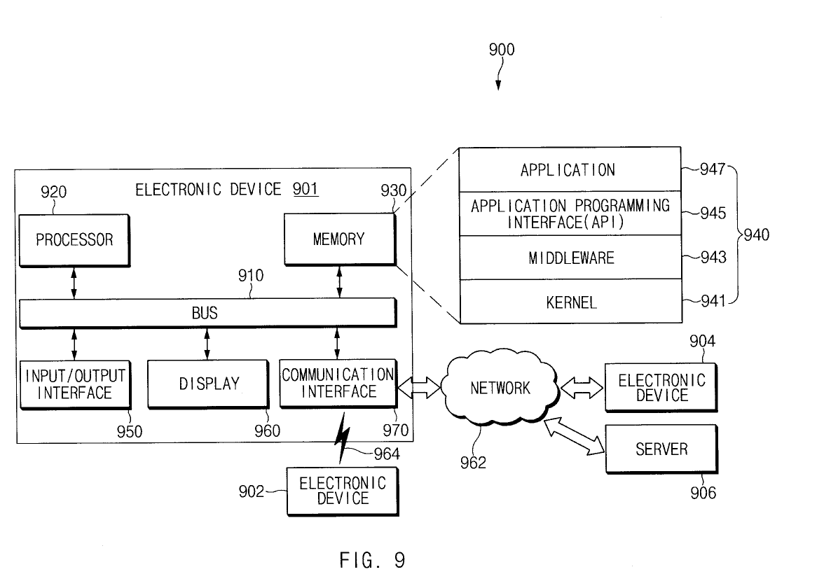

Referring to FIG. 4, an electronic device 401 according to an embodiment of the present disclosure may include a communication circuit 410, a memory 420, and a processor 430. The electronic device 401 may correspond to, for example, the electronic device 10 of FIG. 1. Furthermore, the electronic device 401 may additionally include various modules which are not illustrated in FIG. 4 (e.g., refer to FIG. 9).

The communication circuit 410 may communicate with a base station 402 based on a designated protocol. The communication circuit 410 may additionally include, for example, various elements for providing a communication function such as an RF module, an oscillator, a driver, and the like. A reference signal (RS) may be received from the base station 402 through the communication circuit 410 and a CQI index may be sent to the base station 402. As described above, the base station 402 may perform an AMC based on the CQI index.

For example, the designated protocol for communicating with the base station 402 may include a long-term evolution (LTE) or a LTE-Advanced (LTE-A).

The memory 420 may include at least one of a first application 421 or a second application 422. According to an embodiment, the second application 422 may correspond to an application that utilizes communication latency lower than that of the first application 421. That is, the second application 422 may utilize a response speed faster than that of the first application 421. If the retransmission rate of data increases because a response is delayed, the second application 422 may correspond to an application where the performance may significantly impact user experience. As a block error rate (BLER) decreases, the service quality by the second application 422 may increase.

For example, the second application 422 may include a voice/video call application, a data streaming application, an application according to a rich communication suite (RCS), and the like. As described above, in various types of second applications, a service quality may depend on whether to provide a service in real time.

Meanwhile, the first application 421 may correspond to, for example, an application that does not need to operate in real time, that is unrelated to the retransmission of data, and that does not utilize low communication latency. For example, the first application 421 may include a file download application, a web browsing application, and the like.

The processor 430 may include, for example, a communication processor (CP) 431 and an application processor (AP) 432. In the present disclosure, the CP 431 and the AP 432 may be simply used as the processor 430, it is understood that an operation of each of the CP 431 and the AP 432 is also an operation of the processor 430. The processor 430 may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

According to various embodiments, the CP 431 may be configured to determine a CQI index based on a signal received from the base station 402 and to send the determined CQI index to the base station 402 through an uplink control channel (e.g., PUCCH) or an uplink shared channel (e.g., PUSCH). The scheme for determining the CQI index may be set, for example, by the AP 432.

According to an embodiment, the AP 432 may execute various applications (e.g., the first application 421 and the second application 422) stored in the memory 420. The AP 432 may select different schemes for determining the CQI index based on the application being executed. According to an embodiment, the first application 421 and the second application 422 may be executed at the same time. In this case, the AP 432 may select a scheme for determining the CQI index based on an application of which the usage of communication data is high.

According to an embodiment, if the first application 421 is executed, the AP 432 may control the CP 431 such that the CQI index is determined according to a first scheme for determining the CQI index. For example, if the first application 421 is executed, the CP 431 may measure a signal to noise ratio (SNR) of a signal received from the base station 402, determining a CQI index based on a BLER corresponding to the measured SNR. For example, the CP 431 may select the greatest CQI index from among CQI indices in which the BLER is less than a first threshold value (e.g., 10%).

The CP 431 may decode the reference signal (RS) inserted into a resource block sent from the base station 402, and select the greatest CQI index from among CQI indices in which the BLER does not exceed 10%. For example, in case where the selected CQI index is 6, a BLER of the next larger CQI index 7 exceeds 10%, while a BLER of the next smaller CQI index, 5 is well below 10%.

Meanwhile, according to an embodiment, if the second application 422 is executed, the AP 432 may control the CP 431 such that a CQI index is determined according to a second scheme for determining the CQI index. For example, if the second application 422 is executed, the CP 431 may measure a SNR of a signal received from the base station 402, determining a CQI index based on a transmission rate corresponding to the measured SNR. For example, the CP 431 may select the greatest CQI index from among CQI indices of which transmission rates are saturated, where a BLER corresponding to the determined

CQI index is less than a second threshold value (e.g., 1%) in the measured SNR. The second threshold value may be smaller than the first threshold value.

Meanwhile, the SNR may be measured by, for example, the CP 431. For example, the CP 431 may measure a SNR for each subcarrier of a signal received from the base station 402. The CP 431 may calculate the SNR measured for each subcarrier as an effective SNR based on an exponential effective SNR mapping (EESM) method. The CP 431 may determine a CQI index based on the calculated effective SNR.

According to various embodiments, the SNR may be substituted with a signal to interference plus noise ratio (SINR) determined further on a basis of an interference with another electronic device or a base station.

Moreover, the transmission rate may be also referred to as a transmission speed, throughput, a bit rate, or other proper terms.

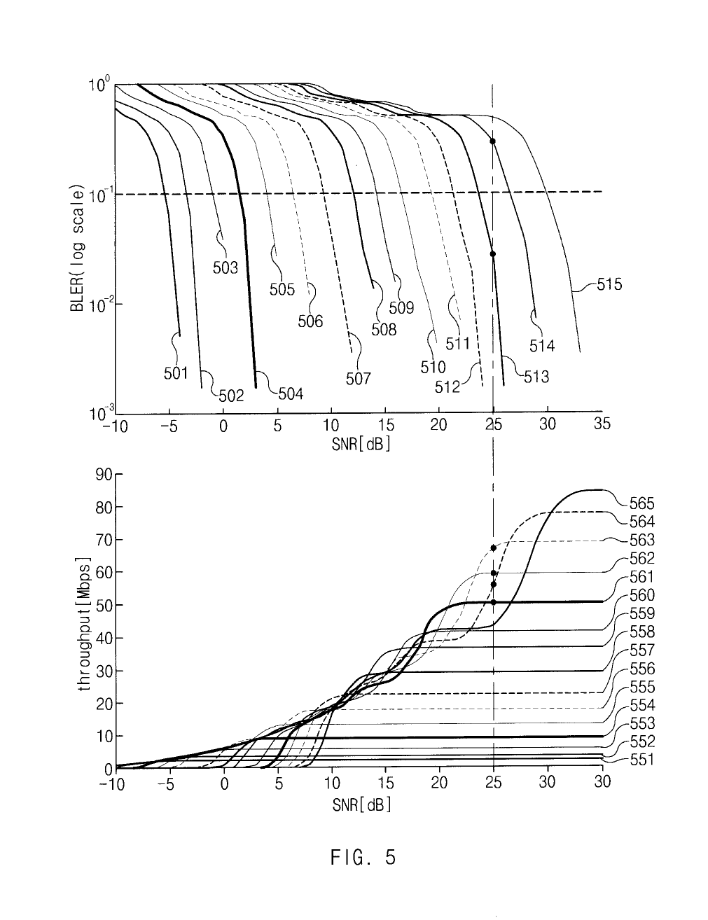

FIG. 5 is a graph for describing relations between an SNR and a CQI index, between an SNR and a BLER, and between an SNR and a transmission rate, according to an embodiment of the present disclosure.

Referring to FIG. 5, curves 501 to 515 in a top graph may mean a relation between a relation between an SNR and a BLER for each CQI index. Moreover, curves 551 to 565 in a bottom graph may mean a relation between a relation between an SNR and a transmission rate for each CQI index. The curves 501 to 515 and the curves 551 to 565 may correspond to curves based on a simulation. According to an embodiment, graphs illustrated in FIG. 5 may be databased and may be stored in the memory 420.

Referring to the curves 501 to 515 illustrated in the top graph of FIG. 5, the abscissa may represent an SNR of a signal received from the base station 402, and the ordinate may represent a BLER. The curves 501 to 515 may correspond to CQI indexes that are 1 to 15, respectively. On the basis of the curves 501 to 515, it may be verified that the BLER significantly decreases as the SNR increases. Moreover, it may be verified that the BLER in a specific SNR significantly increases as the CQI index increases.

For example, it may be verified that the BLER corresponding to the CQI index of ‘13’ is about 0.03 (i.e., 3%) when the SNR is 25 dB (refer to the curve 513). Moreover, it may be verified that the BLER corresponding to the CQI index of ‘14’ is about 0.3 (i.e., 30%) when the SNR is 25 dB (refer to the curve 514).

Accordingly, on the basis of the first scheme for determining the CQI index (in the case where the first application 421 is executed) described in FIG. 4, in the case where the SNR is measured as 25 dB, the CP 431 may determine a CQI index based on the BLER corresponding to 25 dB. That is, in this case, the CP 431 may select a CQI index of ‘13’, which is greatest, from among CQI indexes of ‘1’ to ‘13’ (corresponding to the curves 501 to 513) a BLER of each of which is less than the first threshold value (e.g., 10%).

Referring to the curves 551 to 565 illustrated in the bottom graph of FIG. 5, the abscissa may represent an SNR of a signal received from the base station 402, and the ordinate may represent a transmission rate. The curves 551 to 565 may correspond to CQI indexes that are 1 to 15, respectively. On the basis of the curve 551 to 565, it may be verified that the transmission rate can be significantly increased as the SNR increases. However, it may be verified that the transmission rate is saturated if the SNR reaches a fixed value. Moreover, it may be verified that the transmission rate in a specific SNR significantly increases as the CQI index increases.

For example, it may be verified that when the SNR is 25 dB, the transmission rate corresponding to the CQI index of ‘11’ is about 50 Mbps (i.e., the saturation state) (refer to the curve 561), the transmission rate corresponding to the CQI index of ‘12’ is about 59 Mbps (i.e., the saturation state) (refer to the curve 562), the transmission rate corresponding to the CQI index of ‘13’ is about 67 Mbps (i.e., the unsaturation state) (refer to the curve 563), and the transmission rate corresponding to the CQI index of ‘14’ is about 55 Mbps (i.e., the unsaturation state) (refer to the curve 564).

Accordingly, on the basis of the second scheme for determining the CQI index (in the case where the second application 422 is executed) described in FIG. 4, in the case where the SNR is measured as 25 dB, the CP 431 may determine a CQI index based on the transmission rate corresponding to 25 dB. That is, in this case, the CP 431 may select a CQI index of ‘12’, which is greatest, from among CQI indexes of ‘1’ to ‘12’ (respectively corresponding to the curves 551 to 562) a BLER of each of which is saturated. For a particular SNR (i.e., 25 dB), it may be verified that the BLER is smaller than the second threshold value (e.g., 1%) because a BLER of which the selected CQI index corresponds to ‘12’ is very small.

As verified with reference to the graph, the electronic device 401 may select different schemes for determining the CQI index based on the application being executed. That is, even though the same SNR (e.g., 25 dB) is measured, the CQI index may be determined as ‘13’ based on the first scheme for determining the CQI index, and the CQI index may be determined as ‘12’ based on the second scheme for determining the CQI index.

When the SNR is 25 dB, the BLER corresponding to the CQI index of ‘12’ may be significantly smaller than 1% (i.e., nearly 0.1%), and the transmission rate thereof may be 59 Mbps. Likewise, when the SNR is 25 dB, the BLER and the transmission rate corresponding to the CQI index of ‘13’ may be 3% and 67 Mbps, respectively. As described above, an electronic device may determine an optimal CQI index based on whether the performance that an application utilizes is a transmission rate or a BLER (or transmission latency). For example, in the case where the second application is executed and a realtime or seamless service is provided to a user of an electronic device, there is an advantage that the BLER is lowered by at least 1/10 based on the second scheme for determining the CQI index (i.e., so that a realtime or seamless service may be provided to a user).

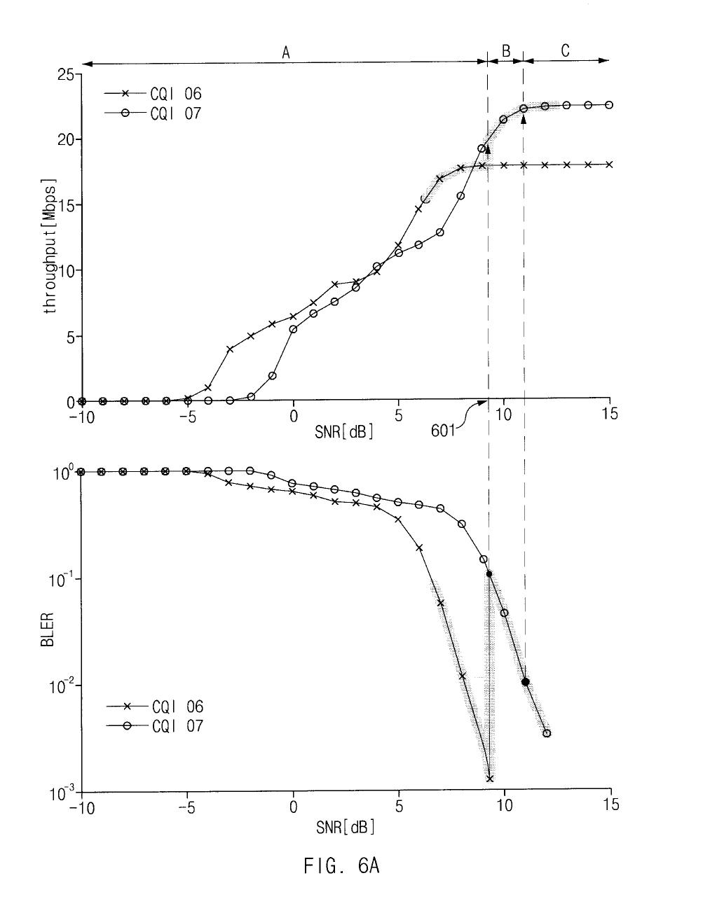

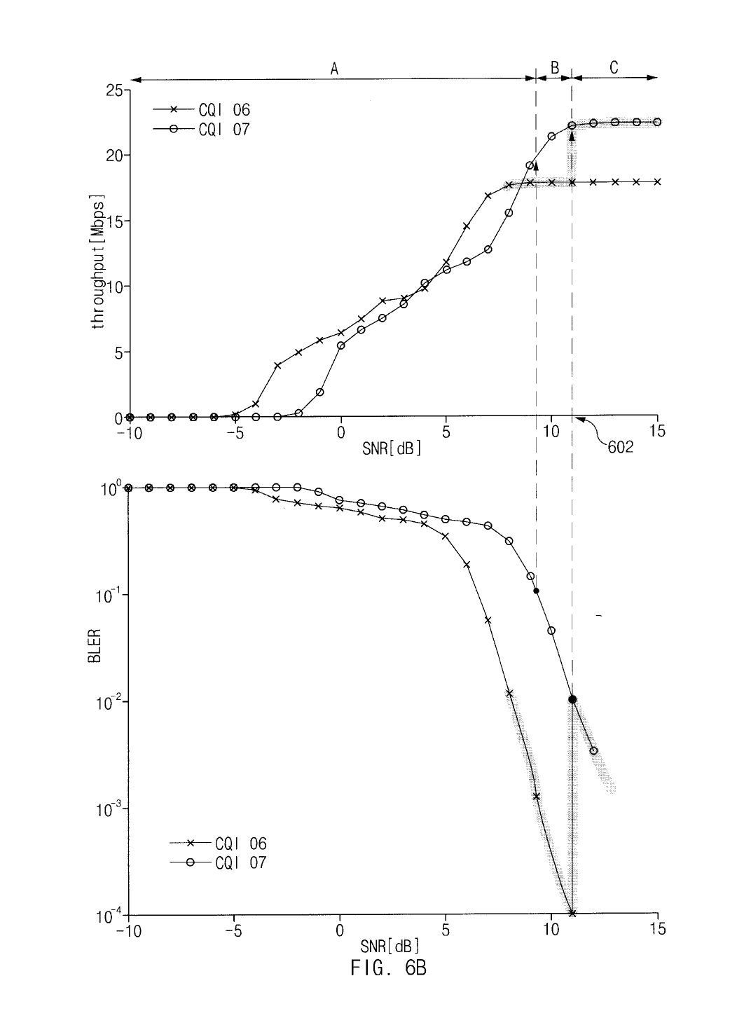

FIGS. 6A and 6B are actual graphs measured for describing relations between an SNR and a CQI index, between an SNR and a BLER, and between an SNR and a transmission rate, according to an embodiment of the present disclosure.

In the case where a channel bandwidth of 10 MHz, an AWGN channel model, and a carrier spacing of 15 kHz are applied thereto, actual graphs measured of FIGS. 6A and 6B may represent relations between an SNR (of a signal received from a base station) and a CQI index, between an SNR and a BLER, and between an SNR and a transmission rate. The actual graphs may be obtained based on an LTE communication between one electronic device (e.g., corresponding to the electronic device 10 of FIG. 1) including 2×2 multiple-input and multiple-output (MIMO) antenna and one base station (e.g., corresponding to the base station 20 of FIG. 1).

Referring to FIG. 6A, an embodiment is exemplified as a CQI index is determined based on the first scheme for determining the CQI index (in the case where the first application 421 is executed) described in FIG. 4. On the basis of FIG. 6A, in the case where the SNR is from about 6.5 dB to 9 dB, it may be verified that the BLER corresponding to the CQI index of ‘6’ is smaller than or equal to 0.1 (i.e., 10% (the first threshold value)). Accordingly, in the case where the SNR is from about 6.5 dB to 9 dB, the CQI index may be determined as ‘6’.

If the SNR reaches about 9 dB, the BLER of which the CQI index corresponds to ‘7’ may decrease to be smaller than 0.1 (i.e., 10% (the first threshold value)). Accordingly, in the case where the SNR is 9 dB (601), the CQI index may be shifted from ‘6’ to ‘7’.

Meanwhile, referring to FIG. 6B, an embodiment is exemplified as a CQI index is determined based on the second scheme for determining the CQI index (in the case where the second application 422 is executed) described in FIG. 4. On the basis of FIG. 6B, in the case where the SNR is about 8 to 11 dB, it may be verified that the transmission rate corresponding to the CQI index of ‘6’ is saturated and the transmission rate corresponding to the CQI index of ‘7’ is not saturated. Accordingly, in the case where the SNR is from about 8 dB to 11 dB, the CQI index may be determined as ‘6’. In the case where the SNR is from about 8 dB to 11 dB, it may be verified that the BLER corresponding to the CQI index of ‘6’ is smaller than or equal to 0.01 (i.e., 1% (the first threshold value)).

If the SNR reaches about 11 dB, the transmission rate corresponding to the CQI index of ‘7’ may be saturated. Accordingly, in the case where the SNR is about 11 dB (602), the CQI index may be shifted from ‘6’ to ‘7’. On the basis of FIG. 6B, after the SNR is about 11 dB (602), it may be verified that the BLER corresponding to the CQI index of ‘7’ is smaller than or equal to 0.01 (i.e., 1% (the second threshold value)).

According to the second scheme (in the case of FIG. 6B), the decrease in a transmission rate may be suppressed within about 8% and correspondingly, the BLER may also be reduced to a level of 1/10 or less, as compared with the first scheme (in the case of FIG. 6A). Accordingly, for a realtime or seamless service (for obtaining low communication latency), maintaining the BLER such that the BLER is lowered may be suitable for the important second application.

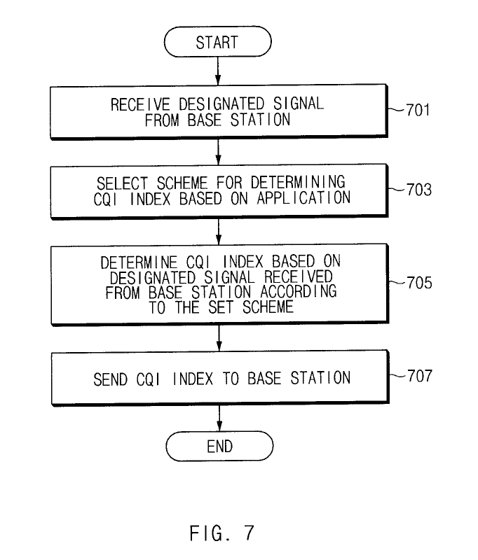

FIG. 7 is a flow chart illustrating a method for determining a CQI index according to an embodiment of the present disclosure.

Referring to FIG. 7, the method for determining a CQI index according to an embodiment of the present disclosure may include operations 701, 703, 705, and 707. For example, each operation of FIG. 7 may be performed by the electronic device 10 illustrated in FIG. 1 or the electronic device 401 illustrated in FIG. 4. Below, each operation of FIG. 7 may be described with reference to a reference number of FIG. 4.

In operation 701, the electronic device 401 may receive a designated signal from the base station 402. The designated signal received from the base station 402 may include a reference signal (RS).

In operation 703, the electronic device 401 may select different schemes for determining a CQI index based on the application being executed at the electronic device 401.

In operation 705, the electronic device 401 may determine a CQI index based on a signal received in operation 701 according to the scheme set in operation 703.

In operation 707, the electronic device 401 may send the CQI index determined in operation 703 to the base station 402. The CQI index may be sent to the base station 402 through an uplink control channel or an uplink shared channel.

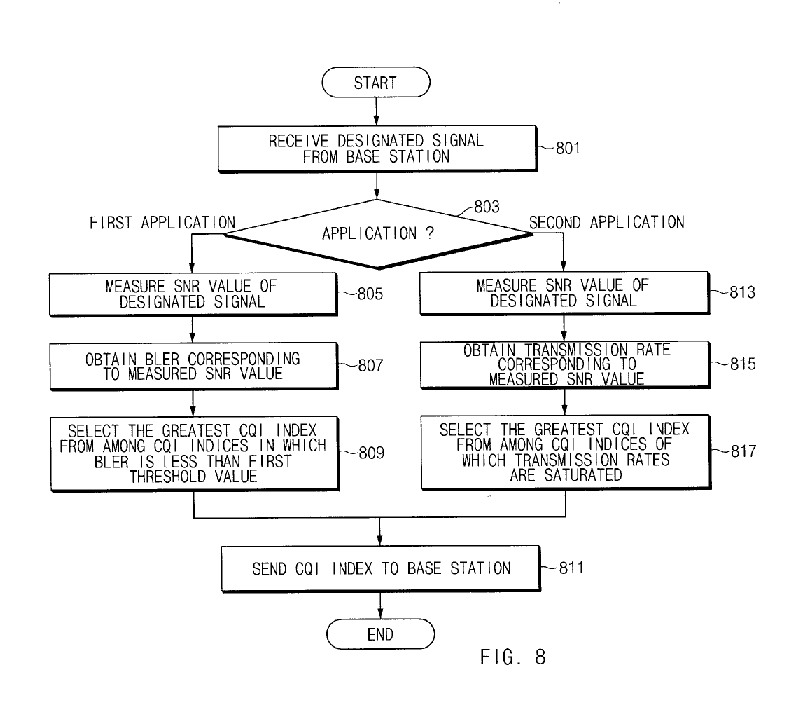

FIG. 8 is a flow chart illustrating a method for determining a CQI index according to an embodiment of the present disclosure.

Referring to FIG. 8, the method for determining a CQI index according to an embodiment of the present disclosure may include operations 801 to 811. Below, each operation of FIG. 8 may be described with reference to a reference number of FIG. 4. Moreover, with regard to FIG. 7, duplicated description may be omitted.

In operation 801, the electronic device 401 may receive a designated signal from the base station 402.

In operation 803, the electronic device 401 may determine whether an application executed at the electronic device 401 is the first application 421 or the second application 422. For example, the second application 422 may correspond to an application that utilizes communication latency lower than that of the first application 421. In the case where the application being executed at the electronic device 401 is the first application 421, the procedure may proceed to operation 805. On the other hand, in the case where the application being executed at the electronic device 401 is the second application 422, the procedure may proceed to operation 813.

In operation 805, the electronic device 401 may measure the SNR of a designated signal received in operation 801. As described above, the SNR may use one of a SNR value and a SINR value.

In operation 807, the electronic device 401 may obtain the BLER corresponding to the measured SNR.

In operation 809, the electronic device 401 may determine a CQI index based on the BLER obtained in operation 807. According to an embodiment, the electronic device 401 may select the greatest CQI index from among CQI indices in which the BLER is less than the first threshold value (e.g., 10%).

In operation 811, the electronic device 401 may send the CQI index determined in operation 809 or 817 to the base station 402.

In operation 813, the electronic device 401 may measure the SNR of a designated signal received in operation 801. Operation 813 may be identical to operation 805.

In operation 815, the electronic device 401 may obtain a transmission rate corresponding to the measured SNR.

In operation 817, the electronic device 401 may determine a CQI index based on the transmission rate obtained in operation 815. According to an embodiment, the electronic device 401 may select the greatest CQI index from among CQI indices of which transmission rates are saturated, where a BLER corresponding to the determined CQI index is less than a second threshold value (e.g., 1%) in the SNR measured in operation 813. In this example where the second application 422 may correspond to an application that utilizes communication latency lower than that of the first application 421, the second threshold value may be smaller than the first threshold value.

The electronic device according to various embodiments of the present disclosure may select different schemes for determining a CQI index based on the application being executed and/or the purpose of data transmission of the application.

For example, if low communication latency is utilized or if the second application of which the main quality factor is a seamless service is executed, an electronic device according to an embodiment may apply the second scheme for determining the CQI index so that a low BLER is obtained (e.g., operations 813, 815, and 817). Moreover, if the first application of which the main quality factor is a transmission speed is executed, an electronic device according to an embodiment may apply the first scheme for determining the CQI index so that a high transmission rate is obtained (e.g., operations 805, 807, and 809).

FIG. 9 is a block diagram of an electronic device in a network environment according to various embodiments of the present disclosure.

Referring to FIG. 9, an embodiment is exemplified as an electronic device 901 is in a network environment 900 according to various embodiments of the present disclosure. For example, the electronic device 901 may correspond to the electronic device 10 of FIG. 1 or the electronic device 401 of FIG. 4.

The electronic device 901 may include a bus 910, a processor 920, a memory 930, an input/output interface 950, a display 960, and a communication interface 970. According to an embodiment of the present disclosure, the electronic device 901 may not include at least one of the above-described components or may further include other component(s).

For example, the bus 910 may interconnect the above-described components 910 to 970 and may be a circuit for conveying communications (e.g., a control message and/or data) among the above-described components.

The processor 920 (e.g., the processor 430 of FIG. 4) may include one or more of a central processing unit CPU, an application processor AP (e.g., the AP 432 of FIG. 4), or a communication processor CP (e.g., the CP 431 of FIG. 4). For example, the processor 920 may perform an arithmetic operation or data processing associated with control and/or communication of at least other components of the electronic device 901.

The memory 930 (e.g., the memory 420) may include a volatile and/or nonvolatile memory. The memory 930 may store instructions or data associated with at least one other component(s) of the electronic device 901. According to an embodiment, the memory 930 may store software and/or a program 940. The program 940 may include, for example, a kernel 941, a middleware 943, an application programming interface (API) 945, and/or an application program (or an application) 947 (e.g., the first application 421 and the second application 422). At least a part of the kernel 941, the middleware 943, or the API 945 may be called an “operating system (OS)”.

For example, the kernel 941 may control or manage system resources (e.g., the bus 910, the processor 920, the memory 930, and the like) that are used to execute operations or functions of other programs (e.g., the middleware 943, the API 945, and the application program 947). Furthermore, the kernel 941 may provide an interface that allows the middleware 943, the API 945, or the application program 947 to access discrete components of the electronic device 901 so as to control or manage system resources.

The middleware 943 may perform a mediation role such that the API 945 or the application program 947 communicates with the kernel 941 to exchange data.

Furthermore, the middleware 943 may process task requests received from the application program 947 according to a priority. For example, the middleware 943 may assign the priority, which makes it possible to use a system resource (e.g., the bus 910, the processor 920, the memory 930, or the like) of the electronic device 901, to at least one of the application program 947. For example, the middleware 943 may process the one or more task requests according to the priority assigned to the at least one, which makes it possible to perform scheduling or load balancing on the one or more task requests.

The API 945 may be, for example, an interface through which the application program 947 accesses a function provided by the kernel 941 or the middleware 943, and may include, for example, at least one interface or function e.g., an instruction for a file control, a window control, image processing, a character control, or the like.

The I/O interface 950 may transmit an instruction or data, input from a user or another external device, to other component(s) of the electronic device 901. Furthermore, the input/output interface 950 may output an instruction or data, received from other component(s) of the electronic device 901, to a user or another external device.

The display 960 may include, for example, a liquid crystal display (LCD), a light-emitting diode (LED) display, an organic LED (OLED) display, a microelectromechanical systems (MEMS) display, or an electronic paper display. The display 960 may display, for example, various contents (e.g., a text, an image, a video, an icon, a symbol, and the like) to a user. The display 960 may include a touch screen and may receive, for example, a touch, gesture, proximity, or hovering input using an electronic pen or a part of a user's body.

The communication interface 410 (e.g., the communication circuit of FIG. 4) may establish communication between the electronic device 901 and an external device (e.g., the external device 902, the external electronic device 904, or a server device 906). For example, the communication interface 970 may be connected to a network 962 through wireless communication or wired communication to communicate with the external device (e.g., the second external electronic device 904 or the server 906).

The wireless communication may include at least one of, for example, LTE, LTE-A, CDMA, WCDMA, UMTs, WiBro, or GSM as cellular communication protocol. Furthermore, the wireless communication may include, for example, a local area network 964. The local area network 964 may include at least one of, for example, a wireless fidelity (Wi-Fi), a Bluetooth, a near field communication (NFC), or a global navigation satellite system (GNSS). The GNSS may include at least one of a global positioning system (GPS), a global navigation satellite system (Glonass), Beidou Navigation Satellite System (hereinafter referred to as “Beidou”), or the European global satellite-based navigation system (Galileo). Hereinafter “GPS” and “GNSS” may be used interchangeably in this disclosure. The wired communication may include at least one of, for example, a universal serial bus (USB), a high definition multimedia interface (HDMI), a recommended standard-232 (RS-232), a plain old telephone service (POTS), or the like. The network 962 may include at least one of telecommunications networks, for example, a computer network (e.g., LAN or WAN), an Internet, or a telephone network.

Each of the external electronic devices 902 and 904 may be a device of which the type is different from or the same as that of the electronic device 901. According to an embodiment of the present disclosure, the server 906 may include a group of one or more servers. According to various embodiments of the present disclosure, all or a part of operations that the electronic device 901 will perform may be executed by another or plural electronic devices (e.g., the electronic devices 902 and 904 and the server 906). According to an embodiment, in the case where the electronic device 901 executes any function or service automatically or in response to a request, the electronic device 901 may not perform the function or the service internally, but, alternatively additionally, it may request at least a portion of a function associated with the electronic device 101 from other devices (e.g., the electronic devices 902 and 904 and the server 906). The other electronic device (e.g., the electronic device 902 or 904 or the server 906) may execute the requested function or additional function and may transmit the execution result to the electronic device 901. The electronic device 901 may provide the requested function or service using the received result or may additionally process the received result to provide the requested function or service. To this end, for example, cloud computing, distributed computing, or client-server computing may be used.

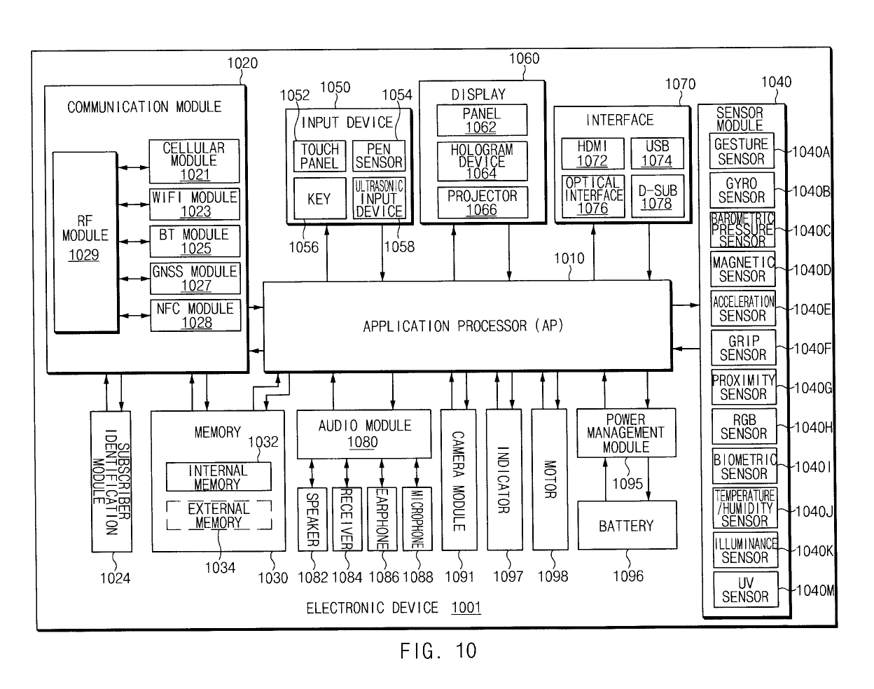

FIG. 10 is a block diagram of an electronic device according to various embodiments of the present disclosure.

Referring to FIG. 10, an electronic device 1001 may include, for example, all or a part of an electronic device 901 illustrated in FIG. 9. The electronic device 1001 may include one or more processors (e.g., an AP) 1010, a communication circuit 1020, a subscriber identification module 1024, a memory 1030, a sensor module 1040, an input device 1050, a display module 1060, an interface 1070, an audio module 1080, a camera module 1091, a power management module 1095, a battery 1096, an indicator 1097, and a motor 1098.

The processor 1010 may drive an operating system (OS) or an application to control a plurality of hardware or software components connected to the processor 1010 and may process and compute a variety of data. The processor 1010 may be implemented with a System on Chip (SoC), for example. According to an embodiment, the processor 1010 may further include a graphic processing unit (GPU) and/or an image signal processor. The processor 1010 may include at least a part (e.g., a cellular module 1021) of components illustrated in FIG. 10. The processor 1010 may load and process an instruction or data, which is received from at least one of other components (e.g., a nonvolatile memory), and may store a variety of data at a nonvolatile memory.

The communication circuit 1020 may be configured the same as or similar to a communication interface 970 of FIG. 9. The communication circuit 1020 may include a cellular module 1021, a Wi-Fi module 1023, a Bluetooth (BT) module 1025, a GNSS module 1027 (e.g., a GPS module, a Glonass module, a Beidou module, or a Galileo module), a near field communication (NFC) module 1028, and a radio frequency (RF) module 1029.

The cellular module 1021 may provide voice communication, video communication, a character service, an Internet service, or the like through a communication network. According to an embodiment, the cellular module 1021 may perform discrimination and authentication of the electronic device 1001 within a communication network using the subscriber identification module 1024 (e.g., a SIM card), for example. According to an embodiment of the present disclosure, the cellular module 1021 may perform at least a part of functions that the processor 1010 provides. According to an embodiment of the present disclosure, the cellular module 1021 may include a communication processor (CP).

Each of the Wi-Fi module 1023, the BT module 1025, the GNSS module 1027, and the NFC module 1028 may include a processor for processing data exchanged through a corresponding module, for example. According to various embodiments of the present disclosure, at least a part (e.g., two or more components) of the cellular module 1021, the Wi-Fi module 1023, the BT module 1025, the GPS module 1027, and the NFC module 1028 may be included within one Integrated Circuit (IC) or an IC package.

The RF module 1029 may transmit and receive data, for example, a communication signal (e.g., an RF signal). The RF module 1029 may include a transceiver, a power amplifier module (PAM), a frequency filter, a low noise amplifier (LNA), an antenna, or the like. According to various embodiments, at least one of the cellular module 1021, the Wi-Fi module 1023, the BT module 1025, the GNSS module 1027, or the NFC module 1028 may transmit and receive an RF signal through a separate RF module.

The subscriber identification module 1024 may include, for example, a subscriber identification module and may include unique identify information (e.g., integrated circuit card identifier (ICCID)) or subscriber information (e.g., integrated mobile subscriber identity (IMSI)).

The memory 1030 (e.g., the memory 930) may include an internal memory 1032 or an external memory 1034. For example, the embedded memory 1032 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory), a hard drive, or a solid state drive (SSD).

The external memory 1034 may further include a flash drive such as compact flash (CF), secure digital (SD), micro secure digital (Micro-SD), mini secure digital (Mini-SD), extreme digital (xD), a multimedia card (MMC), a memory stick, or the like. The external memory 1034 may be functionally and/or physically connected to the electronic device 1001 through various interfaces.

The sensor module 1040 may measure, for example, a physical quantity or may detect an operation state of the electronic device 1001. The sensor module 1040 may convert the measured or detected information to an electric signal. For example, the sensor module 1040 may include at least one of a gesture sensor 1040A, a gyro sensor 1040B, a pressure sensor 1040C, a magnetic sensor 1040D, an acceleration sensor 1040E, a grip sensor 1040F, a proximity sensor 1040G, a color sensor 1040H (e.g., a red, green, blue (RGB) sensor), a living body sensor 1040I, a temperature/humidity sensor 1040J, an illuminance sensor 1040K, or an UV sensor 1040M. Although not illustrated, additionally or generally, the sensor module 1040 may further include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 1040 may further include a control circuit for controlling at least one or more sensors included therein. According to an embodiment, the electronic device 1001 may further include a processor which is a part of the processor 1010 or independent of the processor 1010 and is configured to control the sensor module 1040. The processor may control the sensor module 1040 while the processor 920 remains at a sleep state.

The input device 1050 may include a touch panel 1052, a (digital) pen sensor 1054, a key 1056, or an ultrasonic input unit 1058. The touch panel 1052 may use at least one of capacitive, resistive, infrared and ultrasonic detecting methods. Also, the touch panel 1052 may further include a control circuit. The touch panel 1052 may further include a tactile layer to provide a tactile reaction to a user.

The (digital) pen sensor 1054 may be, for example, a part of a touch panel or may include an additional sheet for recognition. The key 1056 may include, for example, a physical button, an optical key, a keypad, and the like. The ultrasonic input device 1058 may detect (or sense) an ultrasonic signal, which is generated from an input device, through a microphone (e.g., a microphone 1088) and may make sure of data corresponding to the detected ultrasonic signal.

The display 1060 (e.g., a display 960) may include a panel 1062, a hologram device 1064, or a projector 1066. The panel 1062 may be configured to be the same as or similar to a display 960 illustrated in FIG. 9. The panel 1062 may be implemented to be flexible, transparent or wearable, for example. The panel 1062 and the touch panel 1052 may be integrated into a single module. The hologram device 1064 may display a stereoscopic image in a space using a light interference phenomenon. The projector 1066 may project light onto a screen so as to display an image. The screen may be arranged in the inside or the outside of the electronic device 1001. According to an embodiment of the present disclosure, the display 1060 may further include a control circuit for controlling the panel 1062, the hologram device 1064, or the projector 1066.

The interface 1070 may include, for example, a high-definition multimedia interface (HDMI) 1072, a universal serial bus (USB) 1074, an optical interface 1076, or a D-subminiature (D-sub) 1078. The interface 1070 may be included, for example, in the communication interface 970 illustrated in FIG. 9. Additionally or generally, the interface 1070 may include, for example, a mobile high definition link (MHL) interface, a SD card/multi-media card (MMC) interface, or an infrared data association (IrDA) standard interface.

The audio module 1080 may convert a sound and an electric signal in dual directions. At least a part of the audio module 1080 may be included, for example, in an input/output interface 950 illustrated in FIG. 9. The audio module 1080 may process, for example, sound information that is inputted or outputted through a speaker 1082, a receiver 1084, an earphone 1086, or a microphone 1088.

The camera module 1091 for shooting a still image or a video may include, for example, at least one image sensor (e.g., a front sensor or a rear sensor), a lens (not illustrated), an image signal processor (ISP, not illustrated), or a flash (e.g., an LED or a xenon lamp, not illustrated).

The power management module 1095 may manage, for example, power of the electronic device 1001. According to an embodiment, a power management integrated circuit (PMIC), a charger IC, or a battery or fuel gauge may be included in the power management module 1095. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 1096 and a voltage, current or temperature thereof while the battery is charged. The battery 1096 may include, for example, a rechargeable battery and/or a solar battery.

The indicator 1097 may display a specific state of the electronic device 1001 or a part thereof (e.g., the processor 1010), such as a booting state, a message state, a charging state, and the like. The motor 1098 may convert an electrical signal into a mechanical vibration and may generate the following effects: vibration, haptic, and the like. Even though not illustrated, a processing device (e.g., a GPU) for supporting a mobile TV may be included in the electronic device 1001. The processing device for supporting a mobile TV may process media data according to the standards of digital multimedia broadcasting (DMB), digital video broadcasting (DVB), MediaFlo™, or the like.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

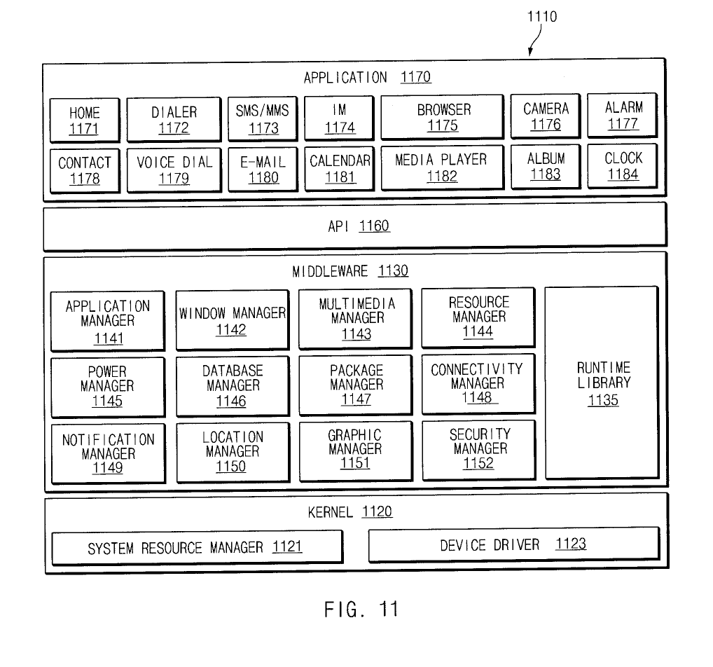

FIG. 11 illustrates a block diagram of a program module 1110 according to various embodiments of the present disclosure.

Referring to FIG. 11, according to an embodiment of the present disclosure, a program module 1110 (e.g., a program 940) may include an operating system (OS) to control resources associated with an electronic device (e.g., an electronic device 901), and/or diverse applications (e.g., an application program 947) driven on the OS. The OS may be, for example, android, iOS, Windows, Symbian, Tizen, or Bada.

The program module 1110 may include a kernel 1120, a middleware 1130, an application programming interface (API) 1160, and/or an application 1170. At least a part of the program module 1110 may be preloaded on an electronic device or may be downloadable from an external electronic device (e.g., an electronic device 902 or 904, a server 906, and the like).

The kernel 1120 (e.g., a kernel 941) may include, for example, a system resource manager 1121 or a device driver 1123. The system resource manager 1121 may perform control, allocation, or retrieval of system resources. According to an embodiment of the present disclosure, the system resource manager 1121 may include a process managing part, a memory managing part, or a file system managing part. The device driver 1123 may include, for example, a display driver, a camera driver, a Bluetooth driver, a common memory driver, an USB driver, a keypad driver, a Wi-Fi driver, an audio driver, or an inter-process communication (IPC) driver.

The middleware 1130 may provide, for example, a function which the application 1170 needs in common, or may provide diverse functions to the application 1170 through the API 1160 to allow the application 1170 to efficiently use limited system resources of the electronic device. According to an embodiment of the present disclosure, the middleware 1130 (e.g., a middleware 943) may include at least one of a runtime library 1135, an application manager 1141, a window manager 1142, a multimedia manager 1143, a resource manager 1144, a power manager 1145, a database manager 1146, a package manager 1147, a connectivity manager 1148, a notification manager 1149, a location manager 1150, a graphic manager 1151, or a security manager 1152.

The runtime library 1135 may include, for example, a library module which is used by a compiler to add a new function through a programming language while the application 1170 is being executed. The runtime library 1135 may perform input/output management, memory management, or capacities about arithmetic functions.

The application manager 1141 may manage, for example, a life cycle of at least one application of the application 1170. The window manager 1142 may manage a GUI resource which is used in a screen. The multimedia manager 1143 may identify a format for playing diverse media files, and may perform encoding or decoding of media files by using a codec suitable for the format. The resource manager 1144 may manage resources such as a storage space, memory, or source code of at least one application of the application 1170.

The power manager 1145 may operate, for example, with a basic input/output system (BIOS) to manage a battery or power, and may provide power information for an operation of an electronic device. The database manager 1146 may generate, search for, or modify database which is to be used in at least one application of the application 1170. The package manager 1147 may install or update an application which is distributed in the form of package file.

The connectivity manager 1148 may manage, for example, wireless connection such as Wi-Fi or Bluetooth. The notification manager 1149 may display or notify an event such as arrival message, promise, or proximity notification in a mode that does not disturb a user. The location manager 1150 may manage location information of an electronic device. The graphic manager 1151 may manage a graphic effect that is provided to a user, or manage a user interface relevant thereto. The security manager 1152 may provide a general security function for system security or user authentication. According to an embodiment of the present disclosure, in the case where an electronic device (e.g., an electronic device 901) includes a telephony function, the middleware 1130 may further includes a telephony manager for managing a voice or video call function of the electronic device.

The middleware 1130 may include a middleware module that combines diverse functions of the above-described components. The middleware 1130 may provide a module specialized to each OS kind to provide differentiated functions. Additionally, the middleware 1130 may remove a part of the preexisting components, dynamically, or may add a new component thereto.

The API 1160 (e.g., an API 945) may be, for example, a set of programming functions and may be provided with a configuration which is variable depending on an OS. For example, in the case where an OS is the android or the iOS, it may be permissible to provide one API set per platform. In the case where an OS is the Tizen, it may be permissible to provide two or more API sets per platform.

The application 1170 (e.g., the application program 947) may include, for example, one or more applications capable of providing functions for a home 1171, a dialer 1172, an SMS/MMS 1173, an instant message (IM) 1174, a browser 1175, a camera 1176, an alarm 1177, a contact 1178, a voice dial 1179, an e-mail 1180, a calendar 1181, a media player 1182, am album 1183, and a timepiece or clock 1184, or for offering health care (e.g., measuring an exercise quantity or blood sugar) or environment information (e.g., atmospheric pressure, humidity, or temperature).

According to an embodiment of the present disclosure, the application 1170 may include an application (hereinafter referred to as “information exchanging application” for descriptive convenience) to support information exchange between the electronic device (e.g., an electronic device 901) and an external electronic device (e.g., an electronic device 902 or 904). The information exchanging application may include, for example, a notification relay application for transmitting specific information to the external electronic device, or a device management application for managing the external electronic device.

For example, the information exchanging application may include a function of transmitting notification information, which arise from other applications (e.g., applications for SMS/MMS, e-mail, health care, or environmental information), to an external electronic device (e.g., an electronic device 902 or 904). Additionally, the information exchanging application may receive, for example, notification information from an external electronic device and provide the notification information to a user.

The device management application may manage (e.g., install, delete, or update), for example, at least one function (e.g., turn-on/turn-off of an external electronic device itself (or a part of components) or adjustment of brightness (or resolution) of a display) of the external electronic device (e.g., the electronic device 902 or 904) which communicates with the electronic device, an application running in the external electronic device, or a service (e.g., a call service, a message service, or the like) provided from the external electronic device.

According to an embodiment of the present disclosure, the application 1170 may include an application (e.g., a health care application) which is assigned in accordance with an attribute (e.g., an attribute of a mobile medical device as a kind of electronic device) of the external electronic device (e.g., an electronic device 902 or 904). According to an embodiment of the present disclosure, the application 1170 may include an application which is received from an external electronic device (e.g., the server 906 or the electronic device 902 or 904). According to an embodiment of the present disclosure, the application 1170 may include a preloaded application or a third party application which is downloadable from a server. The component titles of the program module 1110 according to the embodiment of the present disclosure may be modifiable depending on kinds of OSs.

According to various embodiments of the present disclosure, at least a part of the program module 1110 may be implemented by software, firmware, hardware, or a combination of two or more thereof At least a part of the program module 1110 may be implemented (e.g., executed), for example, by a processor (e.g., the processor 1010). At least a part of the program module 1110 may include, for example, modules, programs, routines, sets of instructions, or processes, or the like for performing one or more functions.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof The “module” may be a minimum unit for performing one or more functions or a part thereof The “module” may be implemented mechanically or electronically. For example, the “module” may include at least one of an application-specific IC (ASIC) chip, a field-programmable gate array (FPGA), and a programmable-logic device for performing some operations, which are known or will be developed. The terms “unit” or “module” referred to herein is further to be understood as comprising hardware such as a processor or microprocessor configured for a certain desired functionality, or a non-transitory medium comprising machine executable code, in accordance with statutory subject matter under 35 U.S.C. §101 and does not constitute software per se.

At least a part of an apparatus (e.g., modules or functions thereof) or a method (e.g., operations) according to various embodiments of the present disclosure may be, for example, implemented by instructions stored in a computer-readable storage media in the form of a program module. The instruction, when executed by one or more processors (e.g., a processor 920), may cause the one or more processors to perform a function corresponding to the instruction. The computer-readable storage media, for example, may be the memory 930.

A computer-readable recording medium may include a hard disk, a magnetic media, a floppy disk, a magnetic media (e.g., a magnetic tape), an optical media (e.g., a compact disc read only memory (CD-ROM) and a digital versatile disc (DVD), a magneto-optical media (e.g., a floptical disk), and hardware devices (e.g., a read only memory (ROM), a random access memory (RAM), or a flash memory). Also, the program instructions may include not only a mechanical code such as things generated by a compiler but also a high-level language code executable on a computer using an interpreter. The above hardware unit may be configured to operate via one or more software modules for performing an operation of the present disclosure, and vice versa.

A module or a program module according to various embodiments of the present disclosure may include at least one of the above elements, or a part of the above elements may be omitted, or additional other elements may be further included. Operations performed by a module, a program module, or other elements according to various embodiments of the present disclosure may be executed sequentially, in parallel, repeatedly, or in a heuristic method. Also, a part of operations may be executed in different sequences, omitted, or other operations may be added.

The electronic device according to various embodiments of the present disclosure may differently set a method for determining a CQI index based on a performed application and/or the purpose of data transmission of the application. Besides, a variety of effects directly or indirectly understood through the present disclosure may be provided.

While the present disclosure has been shown and described with reference to various embodiments thereof, it will be understood by those skilled in the art that various changes in form and details may be made therein without departing from the present disclosure as defined by the appended claims and their equivalents.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, or a combination hardware configured with machine executable code and may be performed in whole or in part within the programmed instructions of a computer. No claim element herein is to be construed under the provisions of 35 U.S.C. 112, sixth paragraph, unless the element is expressly recited using the phrase “means for.”

What is claimed is:

1. An electronic device, comprising:
a communication circuit configured to communicate with a base station based on a protocol;
a memory configured to store one or more applications and one or more schemes for determining channel quality indication (CQI) indices; and
a processor configured to determine a CQI index based on a signal received from the base station through the communication circuit and to cause the communication circuit to send the determined CQI index to the base station,
wherein the processor selects a scheme for determining the CQI index based on the application being executed.

2. The electronic device of claim 1, wherein when a first application is executed, the processor is configured to measure a signal to noise ratio (SNR) of the signal received from the base station and to determine the CQI index based on a block error rate (BLER) corresponding to the measured SNR.

3. The electronic device of claim 2, wherein the processor is configured to select the greatest CQI index from among CQI indices in which the BLER is less than a first threshold value.

4. The electronic device of claim 1, wherein when a second application is executed, the processor is configured to measure the SNR of the signal received from the base station and to determine the CQI index based on a transmission rate corresponding to the measured SNR.

5. The electronic device of claim 4, wherein the processor is configured to select the greatest CQI index from among CQI indices of which transmission rates are saturated.

6. The electronic device of claim 4, wherein a BLER corresponding to the determined CQI index is less than a second threshold value in the measured SNR.

7. The electronic device of claim 1, wherein the signal received from the base station comprises a reference signal.

8. The electronic device of claim 1, wherein the processor is configured to cause the communication circuit to send the CQI index to the base station through an uplink control channel or an uplink shared channel.

9. The electronic device of claim 1, wherein the protocol comprises at least one of a long-term evolution (LTE) or a LTE-Advanced (LTE-A).

10. The electronic device of claim 4, wherein the second application utilizes communication latency less than that of a first application.

11. A CQI index determining method of an electronic device, the method comprising:
receiving a signal from a base station;
executing a specified application on the electronic device;
selecting a scheme for determining the CQI index based on the application being executed;
determining the CQI index based on the signal from the base station according to the selected scheme for determining the CQI index; and
sending the CQI index to the base station.

12. The method of claim 11, wherein if a first application is executed, the determining of the CQI index comprises:
measuring an SNR of the signal; and
determining the CQI index based on a BLER corresponding to the measured SNR.

13. The method of claim 12, wherein the determining of the CQI index based on the BLER comprises:
selecting the greatest CQI index from among CQI indices in which the BLER is less than a first threshold value.

14. The method of claim 11, wherein when a second application is executed, the determining of the CQI index comprises:
measuring an SNR of the signal; and
determining the CQI index based on a transmission rate corresponding to the measured SNR.

15. The method of claim 14, wherein the determining of the CQI index based on the transmission rate comprises:
selecting the greatest CQI index from among CQI indices of which transmission rates are saturated.

16. The method of claim 14, wherein a BLER corresponding to the determined CQI index is less than a second threshold value in the measured SNR.

17. The method of claim 11, wherein the signal received from the base station comprises a reference signal.

18. The method of claim 11, wherein the CQI index is sent to the base station through an uplink control channel or an uplink shared channel.

19. The method of claim 14, wherein the second application utilizes communication latency less than that of a first application.

20. A computer-readable recording medium having recorded thereon instructions which are executed by at least one processor, causing the processor to perform a method, the method comprising:
receiving a signal from a base station;
executing a specified application on the electronic device;
selecting a scheme for determining a CQI index based on the application being executed;
determining the CQI index based on the signal from the base station according to the selected scheme for determining the CQI index; and
sending the CQI index to the base station.
